(19) United States
(12) Patent Application Publication
(10) Pub. No.: US 2007/0280206 A1
(43) Pub. Date: Dec. 6, 2007

(54) Method for consuming heterogeneous services on heterogeneous devices using script plugins

(75) Inventors: Alan Messer, Los Gatos, CA (US); Mithun Sheshagiri, Berkeley, CA (US); Praveen Kumar, San Jose, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/444,961

(22) Filed: May 31, 2006

(51) Int. Cl. H04L 12/66

(52) U.S. Cl. 370/352; 370/401

(57) ABSTRACT

A system and method that map services that are available on the internet to services that can be used by home network devices. Similar services are accessed by a single interface. A “light-weight” plugin mechanism is provided which enables the addition of new functionalities and services. As such, the system can be implemented in a gateway device in the network. Addition of new services can be achieved during run-time, without the need for compilation. Plugins are dynamically obtained via Web-based service providers when needed, whereby it is ensured that the user will use the version of plugins desired by Web-based service providers.

### FIELD OF THE INVENTION

The present invention relates to mapping services on the Internet to services that can be used by devices.

### BACKGROUND OF THE INVENTION

With the proliferation of local networks, such as home networks, and their connectivity to the internet, it is desirable to map services on the Internet to services that can be used by local network devices.

A conventional approach is Windows XP Media Center Edition (WMC) and its add-in framework. WMC is a Windows XP-based platform which provides enhanced media-related functionality for the home network. The platform provides a framework for adding “add-ins” to the network to increase its functionality. Through this mechanism, the network can be made to interact with Web-based service providers.

However, the add-ins framework has several shortcomings. One shortcoming of the add-ins framework is that it is built atop Windows XP, which requires significant computing resources. Another shortcoming of the add-ins framework is that after downloading an add-in, the user must run an installer to install it. Yet another shortcoming of the add-ins framework is that the add-in then resides on the system indefinitely, consuming disk resources.

### BRIEF SUMMARY OF THE INVENTION

In one embodiment the present provides a system and method that map services that are available on the internet to services that can be used by home network devices such as TV. Such a system enables similar services to be accessed by a single interface. For example, all shopping services can be accessed by a single shopping application program interface (API).

The present invention also provides a “light-weight” plugin mechanism that enables the addition of new functionalities and services. In one implementation, the system operates on a gateway device in the network, with limited memory and computational power. Addition of new services can be achieved during run-time, without the need for compilation.

As such, the present invention can be implemented within a resource-constrained environment and does not require the user to perform manual steps to install plugins. Since plugins are dynamically obtained via Web-based service providers when needed, it is ensured that the user will use the version of plugins desired by Web-based service providers.

These and other features, aspects and advantages of the present invention will become understood with reference to the following description, appended claims and accompanying figures.

### BRIEF DESCRIPTION OF THE DRAWINGS

FIG. 1 shows a functional block diagram of an example service mapping and translation system which implements a method of mapping services that are available on the internet to services that can be used by home network devices, according to an embodiment of the present invention.

FIG. 2 shows an example flowchart of steps of service mapping and translation, according to an embodiment of the present invention.

FIG. 3 shows an example functional flow of service mapping and translation, according to an embodiment of the present invention.

FIG. 4 shows an example flowchart of steps of adding GLib plugins for additional services, according to an embodiment of the present invention.

### DETAILED DESCRIPTION OF THE INVENTION

In one embodiment the present provides a system and method that map services that are available on an external network, such as the internet, to services that can be used by a local network devices, such as home network devices (e.g., TV). Such a system enables similar services to be accessed by a single interface. For example, all shopping services can be accessed by a single shopping application program interface (API).

The present invention also provides a “light-weight” plugin mechanism that enables the addition of new functionalities and services. In one implementation, the system is implemented in a gateway device in the network, with limited memory and computational power. Addition of new services can be achieved during run-time, without the need for compilation.

An example implementation of the present invention is now described with reference with the following definitions:
Internet service: A service that can be accessed over the internet. Examples of internet services are amazon.com, google.com, and weather.com.
Service category: A group of similar services is called a service category. For example, Priceline.com and Orbitz.com both offer travel related service and therefore they belong to the same service category.

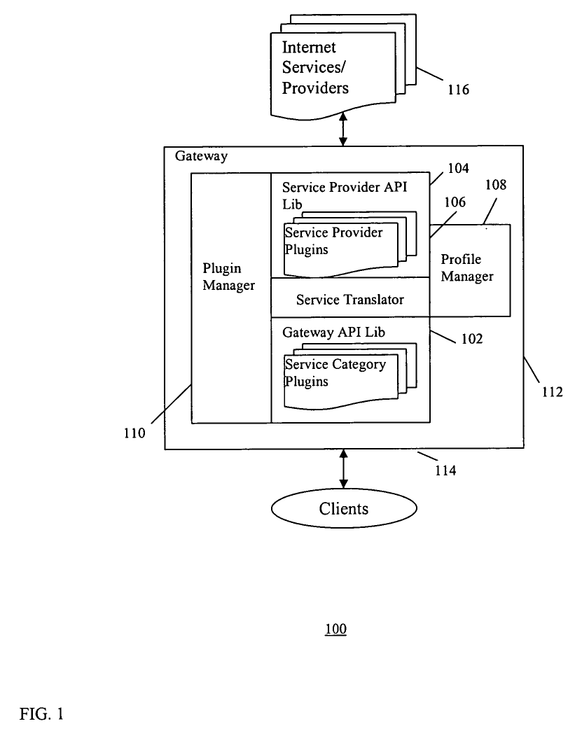

FIG. 1 shows a functional block diagram of an example mapping system 100 which implements a method of mapping services that are available on the internet to services that can be used by home network devices, according to an embodiment of the present invention. The mapping system comprises the following five functional components:
Gateway (client) API Lib: GLib 102.
Service Provider API Lib: SLib 104.
A script based Service Translator: ST 106.
Profile Manager: PM 108.
Plugin Manager: PLM 110.

In this example, the above five functional components are implemented in a device, for example gateway 112, in the network. Each of the above five functional components is further described below.
The Gateway API Lib component 102 (e.g., software module) comprises an interface used by clients 114 (e.g., devices and/or client programs in the home network) to interact with service providers providing internet services 116. Each service category includes one API. The Gateway API Lib (GLib) 102 comprises a collection of APIs, each API corresponding to a method/function in GLib 102. Each API is installed by the Plugin Manager (described further below).
The Service Provider API Lib component (SLib) 104 (e.g., software module) comprises a collection of APIs and corresponding methods/functions in SLib 104, provided by the service providers. Each Service Provider API corresponds to a single service provider. A service provider API allows interaction with the services provided by the service provider. Addition of a new Service Provider API is performed by the Plugin Manager 110 (described further below).
The Service Translator component 106 (e.g., software module) is responsible for translating function calls of the Gateway API Lib 102 into the Service Provider API, and routing information returned from the service provider in response to the call, to the user.
The user initiates the function calls. For example, while buying a product using the shopping API in the GLib 102, the user decides to buy a product. Assume the system has a shopping service category and the user has two service providers (SP) for the shopping category, Amazon and Barnes&Noble (B&N). The GLib 102 includes a buy( ) function that is used for buying from all service providers. When the user decides to buy from Amazon he invokes the buy( ) call from SLib 104 and passes Amazon as the SP. The ST 106 maps this to buyFromAmazon( ) which is part of the SLib 104. If the user chooses to buy from Barnes&Noble, the function call would be buy( ) with Barnes&Noble as a parameter which will be translated by ST 106 as buyFromBarnes&Noble( ). Further, when buyFromAmazon( ) method is executed, it makes a call to the service provider and the service provider returns some information (e.g., receipt of transaction), which information is routed back to the user.
The translation is performed using scripts that map each method in the Gateway API Lib 102 to one or more calls in the Service Provider API. Service Translator 106 interacts with the Profile Manager 108 (described below) to fill-in user information required by an internet service 116. For example, the internet service 116 may require credit card information and user's shipping address. This information is obtained by the Service Translator 106 from the Profile Manager 108. The Service Translator 106 includes a script engine that provides the environment for executing plugins which are coded as scripts.
Method and function are the same. Call is the process of executing the method or function. API is a collection of methods or calls. Suppose Amazon provides a book buying service. The methods are search( ) and buy( ). These methods collectively are known as the API, where:
Amazon API
   1. searchAma( )
   2. buyAma( )
Similarly
B&N API
   1. searchb( )
   2. buyb&n( )
The Profile Manager (PM) component 108 (e.g., software module) manages and supplies user information. The Service Translator 106 uses this information to interact with internet services 116.
The Plugin Manager (PLM) component 110 (e.g., software module) is responsible for adding APIs to Gateway API Lib 102 and Service Provider API using scripts. API are a collection of methods. These methods are codes in scripting languages like JavaScript. The PLM 110 is further responsible for managing the plugins by removing unused ones and adding new ones, on-demand.

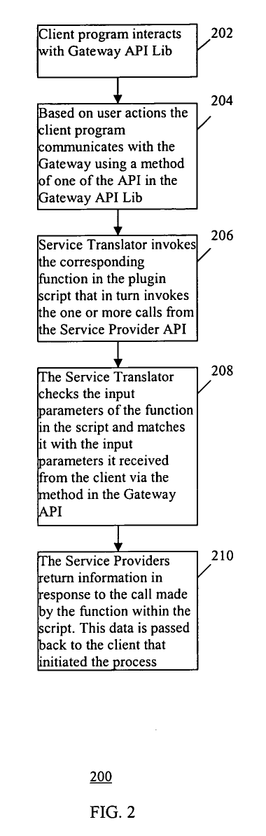

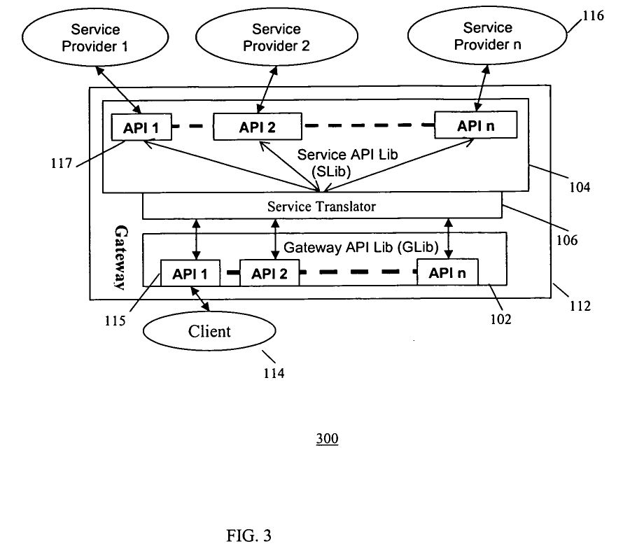

Referring to the example flowchart 200 in FIG. 2 in conjunction with the example service translation flow 300 in FIG. 3, in the example described herein service translation is performed according to the following steps:
Step 202: The user uses a client program 114 to interact with Gateway API Lib 102.
Step 204: Based on user actions the client program 114 communicates with the Gateway 112 using a method of one of an APIs 115 in the Gateway API Lib 102.
Step 206: The Service Translator 106 upon receiving a function call in response to user request, invokes the corresponding function in the plugin script that in turn invokes the one or more calls from the Service Provider API 117. The user, for example presses a button to buy a book from Amazon. In response to this, the buy( ) method in GLib 102 is called. Additionally, Amazon is passed as a parameter. The ST 106 looks at the method:buy( ) and the service provider name:Amazon and makes buyAmazon( ) call, wherein buyAmazon( ) is a method of the Amazon API which resides in SLib 104. It is possible that the method invoked (e.g., buy( )) is realizable by one or more service providers API. For example, a book can be purchased from Amazon or B&N, which means that buy( ) can be mapped to buyAmazon( ) or buyB&N( ). Service Translator 106 chooses one API 117 (e.g., chooses buyAmazon( ) or buyB&N( )) based on user preferences obtained from the Preference Manager. Alternatively, the user can specify the user's preferred service provider. The Preference Manager comprises a module which has information about the user such as user's address, credit card information, etc. The Preference Manager can also have information whether the user prefers a particular service provider (e.g., Amazon or B&N).
Step 208: The Service Translator 106 checks the input parameters of the function in the script and matches it with the input parameters it received from the client 114 via the method in the Gateway API 115. If the function in the script requires more information than what is provided by the client 114, the Profile Manager 108 is queried to obtain this information.
Step 210: The Service Providers returns information in response to the call made by the function within the script. This data is passed back to the client that initiated the process.

### Additions of Plugins

Plugins are software components that are used to add functionality to software systems. In the present invention, new service providers are included by adding plugins. Two example types of plugins in system 100 include SLib (service provide plugins) plugins and GLib plugins (service category plugins) (FIG. 1).

The SLib plugins map methods in the GLib 102 to methods in SLib 104. For example, if the GLib 102 has an API that lets a client 114 search on the internet, a SLib plugin connects this API to a search service on the internet. Search service is a service category. This API in the GLib 102 can be overloaded to make use of more than one search service. To add a new service category (e.g., a shopping plugin), a new service category API should be added to the GLib 102 using a GLib plugin.

Function of a GLib plugin is now described by example. If a user wants to add a feature that allows searching the internet, the user is supposed to have a search( ) method which can be invoked by the user (using the client program). This lets the user invoke a function call to GLib 102. If the user needs to connected to Google, a script with a method is needed which connects to the Google website. This is done by using a service provider script which essentially provides a method searchGoogle( ) and is to be hooked to the search( ) method. As such, the script which provides search( ) is the service category plugin or GLib plugin (because it is part of GLib). Therefore, searchGoogle( ) is a method provided by a service provider and is called the service provider plugin or SLib plugin.

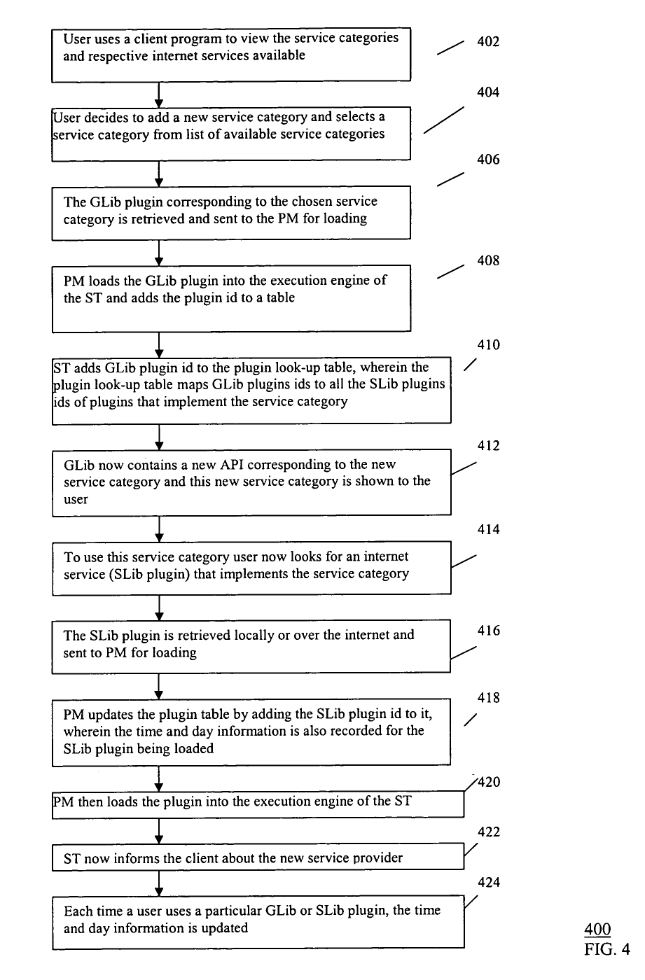

Referring to the example flowchart 400 in FIG. 4, in one example according to the present invention, GLib plugins are added according to the following steps:
Step 402: User uses a client program 114 (FIG. 1) to view the service categories and respective internet services 116 available.
Step 404: User decides to add a new service category and selects a service category from list of available service categories.
Step 406: The GLib plugin corresponding to the chosen service category is retrieved from e.g. the Internet, and sent to the PM 108 for loading.
Step 408: PM 108 loads the GLib plugin into the execution engine of the ST 106 and adds the plugin id to a table (plugin table). Each plugin is identified by a plugin id.
Step 410: ST 106 adds GLib plugin id to the plugin look-up table. The plugin look-up table maps GLib plugins ids to all the SLib plugins ids of plugins that implement the service category.
Step 412: GLib 104 now contains a new API corresponding to the new service category and this new service category is shown to the user.
Step 414: To use this service category, the user now looks for an internet service (SLib plugin) that implements the service category.
Step 416: The SLib plugin is retrieved locally or over the internet and sent to PM 108 for loading.
Step 418: PM 108 updates the plugin table by adding the SLib plugin id to it. The time and day information is also recorded for the SLib plugin being loaded.
Step 420: PM 108 then loads the plugin into the execution engine of the ST 106.
Step 422: ST 106 now informs the client program 114 about the new service provider.
Step 424: Each time a user uses a particular GLib or SLib plugin, the time and day information is updated.

SLib plugins are added when the user requires adding a new service provider to service categories. In one example, the user can have a search feature linked to Google, and may wish to add Yahoo search. This is done by adding SLib plugins.

The techniques here for adding plugins provide benefits including: (1) Adding a plugin without the need for compilation or restarting the system, and (2) Due to the limited availability of memory in gateways, the management of plugin is efficient.

Plugins are written as e.g. European Computer Manufacturers Association (ECMA) scripts. ECMA scripts can be executed without compilation. As a result, plugins can be loaded during run-time and can be immediately used. The example embodiment of the present invention described herein above runs on a gateway which typically has limited memory. In view of this, execution environment in the ST 106 (FIG. 1) is allotted a fixed amount of memory and the PM 108 manages this environment by loading plugins that are required immediately and removing plugins that are not being used. When the PM 108 determines that the execution environment does not have enough memory to load the new plugin, it removes the plugin with the oldest time-stamp in the plugin table.

Alternatively javascripting could be used to deliver and control web content to the device as well as mapping the APIS. Further, the local device may consume the heterogeneous services (i.e., the local device supports services and uses the downloaded scripts to map from the internet service API to the local API on the device).

As such, the present invention can be implemented within a resource-constrained environment and does not require the user to perform manual steps to install plugins. Since plugins are dynamically obtained via Web-based service providers when needed, it is ensured that the user will use the version of plugins desired by Web-based service providers.

While the present invention is susceptible of embodiments in many different forms, there are shown in the drawings and herein described in detail, preferred embodiments of the invention with the understanding that this description is to be considered as an exemplification of the principles of the invention and is not intended to limit the broad aspects of the invention to the embodiments illustrated. The aforementioned example architectures above according to the present invention can be implemented in many ways, such as program instructions for execution by a processor, as logic circuits, as ASIC, as firmware, etc., as is known to those skilled in the art. Therefore, the present invention is not limited to the example embodiments described herein.

The present invention has been described in considerable detail with reference to certain preferred versions thereof; however, other versions are possible. Therefore, the spirit and scope of the appended claims should not be limited to the description of the preferred versions contained herein.

What is claimed is:

1. A system for making services of an external network available to a local network, comprising:
a service provider API module in the local network that allows interaction with services provided by service providers in the external network;
a client API module in the local network that interfaces client programs in the local network to service provider API module; and
a service translator module in the local network that translates client API module function calls into the service provider API module, and routes information returned in response to the call.

2. The system of claim 1 wherein the client API module comprises a collection of APIs and corresponding methods.

3. The system of claim 1 wherein the service provider API module comprises a collection of APIs and corresponding methods.

4. The system of claim 3 wherein each service provider API corresponds to a single service provider.

5. The system of claim 4 wherein each service provider API allows interaction with the services provided by the corresponding service provider.

6. The system of claim 1 wherein the service provider API module, the client API module and the service translator module, are implemented in gateway device in the local network.

7. The system of claim 1 wherein:
the client API module comprises a collection of APIs and corresponding methods;
the service provider API module comprises a collection of APIs and corresponding methods provided by the service providers;
the service translator module translates by mapping each method in the client API module to one or more methods in the service provider API module.

8. The system of claim 7 wherein the service translator module translates using scripts that map each method in the client API module to one or more methods in the service provider API module.

9. The system of claim 8 wherein the service translator module includes a script engine that provides an environment for executing plugins which are coded as scripts.

10. The system of claim 1 further comprising a profile manager that manages and supplies user information, such that the service translator module further interacts with the profile manager to provide user information required by a service provider.

11. The system of claim 1 further comprising a plugin manager that manages a collection of APIs in the service provider API module.

12. The system of claim 11 wherein the plugin manager further adds new service APIs to the service provider module for new service providers.

13. The system of claim 1 further comprising a plugin manager that manages a collection of APIs in the client API module.

14. A method for making services of an external network available to a local network, comprising the steps of:
mapping services that are available on the external network to services for use by a client application in the local network.

15. The method of claim 14 wherein the steps of mapping services further include the steps of:
translating client application requests for service into requests to services provided by service providers in the external network, thereby enabling client applications to interact with services provided by service providers in the external network.

16. The method of claim 14 wherein the steps of mapping services further include the steps of:
providing a service provider interface in the local network that interfaces with service providers in the external network;
providing a client application interface in the local network that interfaces with the client applications; and
providing a service translator in the local network that translates client application service function calls to the client application interface, into function calls in the service provider interface, thereby enabling client applications to interact with services provided by service providers in the external network.

17. The method of claim 16 further including the steps of each service provider providing a service provider API corresponds to that service provider.

18. The method of claim 17 wherein each service provider API allows interaction with the services provided by the corresponding service provider.

19. The method of claim 16 wherein the service provider interface, the client application interface and the service translator, are implemented in gateway device in the local network.

20. The method of claim 16 further including the steps of the service translator translating by mapping each method in the client application interface to one or more methods in the service provider interface.

21. The method of claim 16 further including the steps of:
maintaining user information; and
providing the user information as required by a service provider.

22. The method of claim 16 further comprising the steps of managing a collection of APIs in the service provider interface.

23. The method of claim 22 further comprising the steps of adding new service APIs to the service provider interface for new service providers.

24. The method of claim 16 further comprising the steps of managing a collection of APIs in the client application interface.

25. The method of claim 24 further comprising the steps of adding new API to the client application interface for new services.

26. The method of claim 14 further comprising the steps of:
enabling similar services to be accessed by a single interface in the local network.
